(19) United States
(12) Patent Application Publication
(10) Pub. No.: US 2022/0212840 A1
(43) Pub. Date: Jul. 7, 2022

(54) HINGE ASSEMBLY

(71) Applicant: Loadhog Limited, Sheffield, South Yorkshire (GB)

(72) Inventor: Luke Davis, Sheffield, South Yorkshire (GB)

(21) Appl. No.: 17/610,638

(22) PCT Filed: Jun. 24, 2020
(86) PCT No.: PCT/IB2020/055952

§ 371 Date: Nov. 11, 2021

(30) Foreign Application Priority Data
Jun. 25, 2019 (GB) 1909080.2
Jun. 12, 2020 (GB) 2008936.3
Jun. 23, 2020 (GB) 2009535.2

(51) Int. Cl. B65D 43/16; E05D 5/12

(52) U.S. Cl. CPC B65D 43/165; B65D 2543/00194; B65D 2251/10; E05D 5/125

(57) ABSTRACT

A hinge assembly (15) comprises a first part (12) having a first hinge member (16), and a second part (14) having a second hinge member (18). The first and first and second hinge members (16, 18) form a pivot arrangement (20) to allow the first part (12) to pivot relative to the second part (14). A hinge pin (22) extends across the pivot arrangement (20), thereby pivotally attaching the first part (12) to the second part (14). The hinge pin (22) and the pivot arrangement (20) include a securing arrangement (26) to inhibit extraction of the hinge pin (22) from the pivot arrangement (20).

This invention relates to hinge assemblies. More particularly, but not exclusively, this invention relates to hinge assemblies incorporated in containers. Embodiments of this invention relate to containers incorporating hinge assemblies.

The transport and storage of goods in containers can create a security problem, in that thieves may try to steal the goods from inside the containers, even in situations where the containers have locked lids. Often, thieves can gain access to the goods inside the container by opening the lid at the hinge.

According to one aspect of this invention, there is provided a hinge assembly comprising: a first part having a first hinge member; a second part having a second hinge member, the first and second hinge members forming a pivot arrangement to allow the first part to pivot relative to the second part; and a hinge pin extending across the pivot arrangement, thereby pivotally attaching the first part to the second part; wherein the hinge pin and the pivot arrangement include a securing arrangement to inhibit extraction of the hinge pin from the pivot arrangement.

The hinge assembly may be incorporated in a container. The first part may comprise a wall of the container. The second part may comprise a lid of the container.

According to another aspect of this invention, there is provided a container comprising: a wall, the wall having a first hinge member; a lid, the lid having a second hinge member; the first and second hinge members forming a pivot arrangement to allow the first part to pivot relative to the second part; and a hinge pin extending across the pivot arrangement, thereby pivotally attaching the lid to the wall; wherein the hinge pin and the pivot arrangement include a securing arrangement to inhibit extraction of the hinge pin from the pivot arrangement.

The securing arrangement may comprise interacting securing formations. The pivot arrangement and the hinge pin may have respective interacting securing formations.

The hinge pin may extend through the pivot arrangement. The pivot arrangement and the hinge pin extending therethrough constitute a hinge.

The hinge pin may have a proximal end and a distal end. One of the hinge members may include an end opening. The proximal end may be disposed at said end opening. The hinge pin may be inserted into the pivot arrangement in an orientation in which the distal end leads the proximal end.

The hinge pin may comprise an elongate member. The elongate member may have a proximal end region. The elongate member may have a distal end region. The interacting securing formation of the hinge pin may be provided on the elongate member.

According to another aspect of this invention, there is provided a hinge pin for use with a pivot arrangement, the hinge pin comprising an elongate member having a proximal end region and an opposite distal end region, and an interacting securing formation on the elongate member, the interacting securing formation being configured to interact with a further interacting securing formation of the pivot arrangement.

The interacting securing formations may comprise a detent formation and a shoulder to engage the detent formation. The hinge pin and the pivot arrangement may comprise the securing formations.

One of the hinge pin and the pivot arrangement may include the detent formation. The other of the hinge pin and pivot arrangement may include the shoulder. The hinge pin may include the detent formation. The pivot arrangement may include the shoulder. The shoulder may be provided on one of the first and second hinge members.

The proximal end of the hinge pin may be a proximal end of the elongate member. The proximal end may be provided at the proximal end region of the elongate member. The distal end of the hinge pin may be a distal end of the elongate member. The distal end may be provided at the distal end region of the elongate member.

The interacting securing formation of the hinge pin may be provided at the proximal end of the hinge pin. The interacting securing formation of the hinge pin may be provided at the distal end region of the elongate member.

The first and second hinge members may be aligned to receive the hinge pin. The aligned hinge members may form the pivot arrangement. Each of the first hinge members and each of the second hinge members may define a respective receiving formation for receiving the hinge pin. In the pivot arrangement, the receiving formations of the aligned hinge members may form a channel through which the hinge pin may extend.

The pivot arrangement may have a proximal hinge member at which the proximal end of the hinge pin is disposed when the hinge pin is received by the pivot arrangement. The pivot arrangement may have a distal hinge member at which the distal end of the hinge pin is disposed when the hinge pin is received by the pivot arrangement.

The pivot arrangement may have opposite ends. The end opening may be defined at one of said opposite ends of the pivot arrangement. The end opening may be defined in the proximal hinge member. A respective one of the first hinge members may be provided at each end of the pivot arrangement.

The proximal hinge member may be one of the first hinge members. The distal hinge member may be one of the first hinge members. The end opening may be defined by one of the first hinge members provided at one of the opposite ends of the pivot arrangement.

The interacting securing formation of the pivot arrangement may be provided at one end of the pivot arrangement. The interacting securing formation of the pivot arrangement may be provided on the first hinge member.

The pivot arrangement may have two interacting securing formations. A respective interacting securing formation may be provided at each of the opposite ends of the pivot arrangement. Both interacting securing formations of the pivot arrangement may be provided on respective first hinge members.

Where the hinge pin comprises the detent formation, the detent formation may comprise a projecting member extending from the elongate member away from the distal end. The projecting member may be provided at the proximal end region of the hinge pin. The projecting member may be provided at the distal end region of the hinge pin.

The hinge pin may comprise two of the detent formations. The detent formations may comprise a first projecting member. The first projecting member may be provided at the proximal end region of the hinge pin.

The detent formations may further include a second projecting member. The second projecting member may be provided at the distal end region of the hinge pin. Each projecting may extend from the elongate member towards the proximal end.

The hinge pin may comprise two of the projecting members. The, or each, projecting member may comprise a barb. The, or each, projecting member may project from the elongate member towards the proximal end.

The, or each, projecting member may project from the elongate member in a direction opposite to the direction of insertion of the hinge pin into the pivot arrangement. The, or each, projecting member may project from the elongate member towards the proximal end.

Each of the projecting members may project from a respective end region of the elongate member. Each of the projecting members may project from the elongate member longitudinally along the elongate member. Each of the projecting members may project from the elongate member in the same direction towards one of the ends of the elongate member.

One of the projecting members may be provided adjacent the distal end of the hinge pin. The other of the projecting members may be provided adjacent the proximal end of the hinge pin.

The pivot arrangement may comprise a plurality of the interacting securing formations of the pivot arrangement. The pivot arrangement may comprise two of the interacting securing formations of the pivot arrangement. The interacting securing formations of the pivot arrangement may be provided at the opposite ends of the pivot arrangement.

Each of the interacting securing formations of the pivot arrangement may comprise a respective shoulder. A first of the shoulders may be provided at one end of the pivot arrangement. A second of the shoulders may be provided at the opposite end of the pivot arrangement.

The first part may comprise a plurality of the first hinge members. The second part may comprise a plurality of the second hinge members. The wall may comprise a plurality of the first hinge members. The lid may comprise a plurality of the second hinge members.

The first and second hinge members may alternate respect to one another to form the pivot arrangement.

The, or each, first hinge member may comprise a main portion. The interacting securing formation of the pivot arrangement may be provided on the main portion. The, or each, second hinge member may comprise a main portion.

The interacting securing formations of the pivot arrangement may be provided on a plurality of the first hinge members. The interacting securing formations of the pivot arrangement may be provided on two of the first hinge members. The interacting securing formations of the pivot arrangement may be provided on each of the first hinge members provided at the opposite ends of the pivot arrangement.

The interacting securing formation of the pivot arrangement may be provided on the, or one of the, first hinge members. The interacting securing formation of the pivot arrangement may be provided at one end of the pivot arrangement.

Each interacting securing formation of the pivot arrangement may be provided on a respective one of first hinge members. Each of the interacting securing formations of the pivot arrangement may be provided at a respective opposite end of the pivot arrangement.

The hinge pin may include a stop formation to engage the pivot arrangement at said end opening. The stop formation may be provided at the proximal end of the hinge pin.

An embodiment of the invention will now be described by way of example only, with reference to the accompanying drawings, in which:

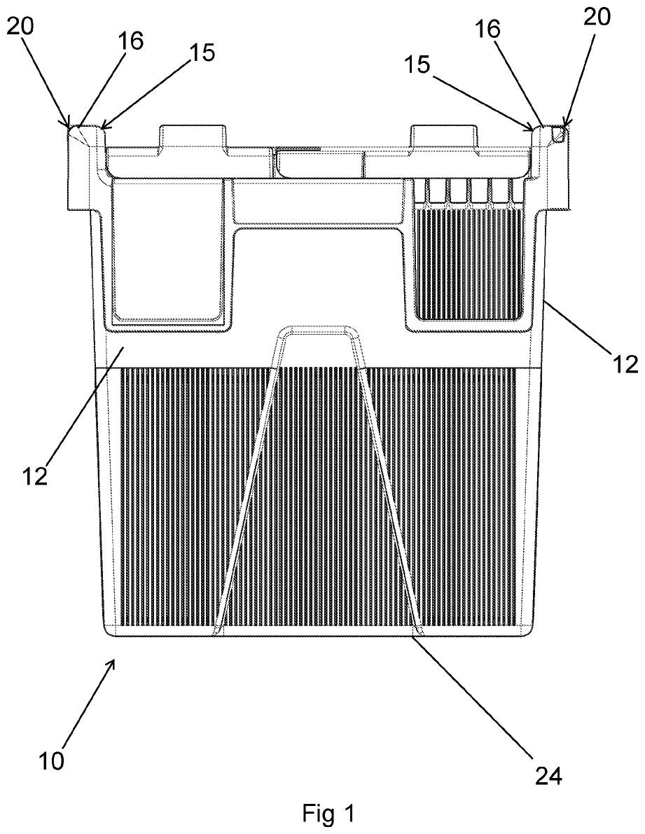

FIG. 1 is an end view of a container;

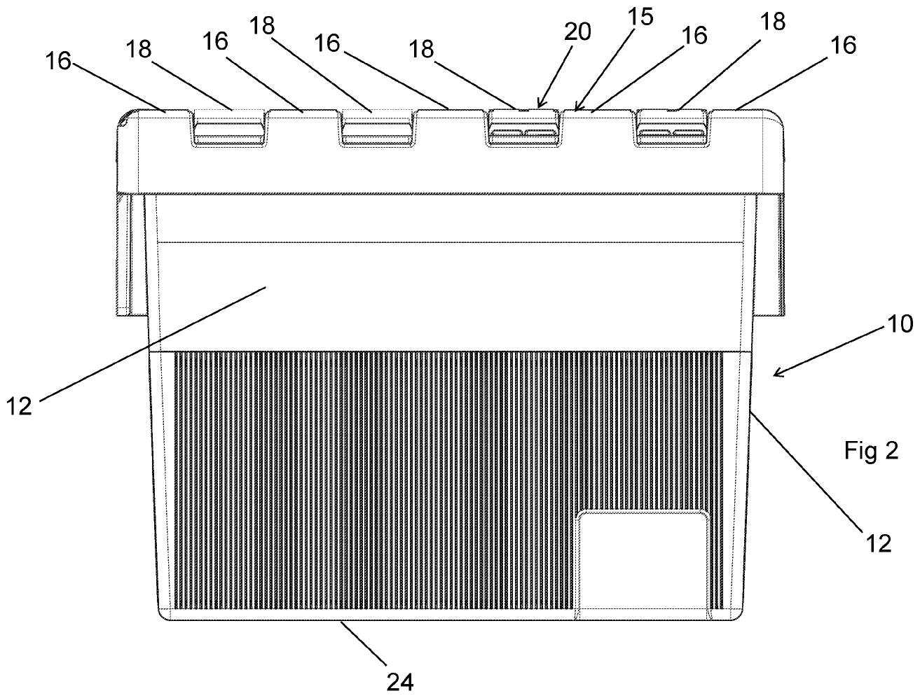

FIG. 2 is a side view of the container;

FIG. 3 is a view of a hinge assembly forming part of the container;

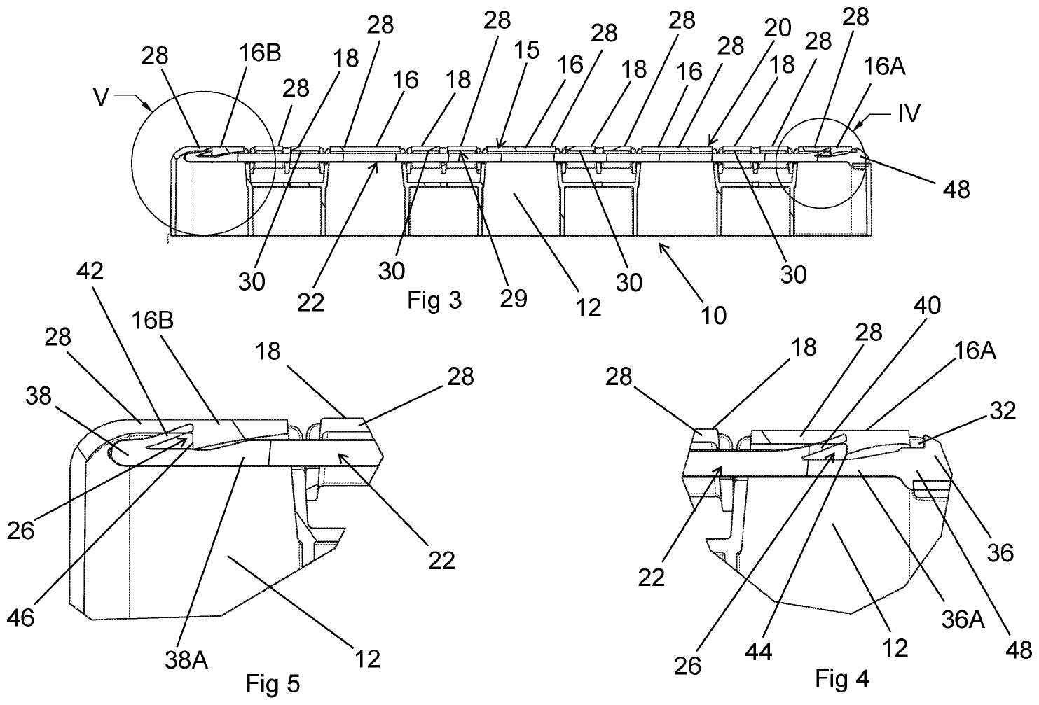

FIG. 4 is a close up of the region marked IV in FIG. 3;

FIG. 5 is a close up of the region marked V in FIG. 3;

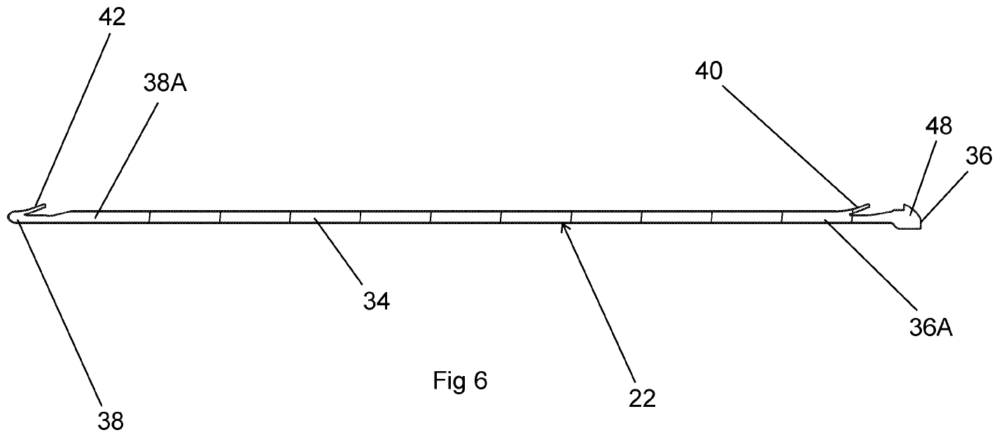

FIG. 6 shows a hinge pin; and

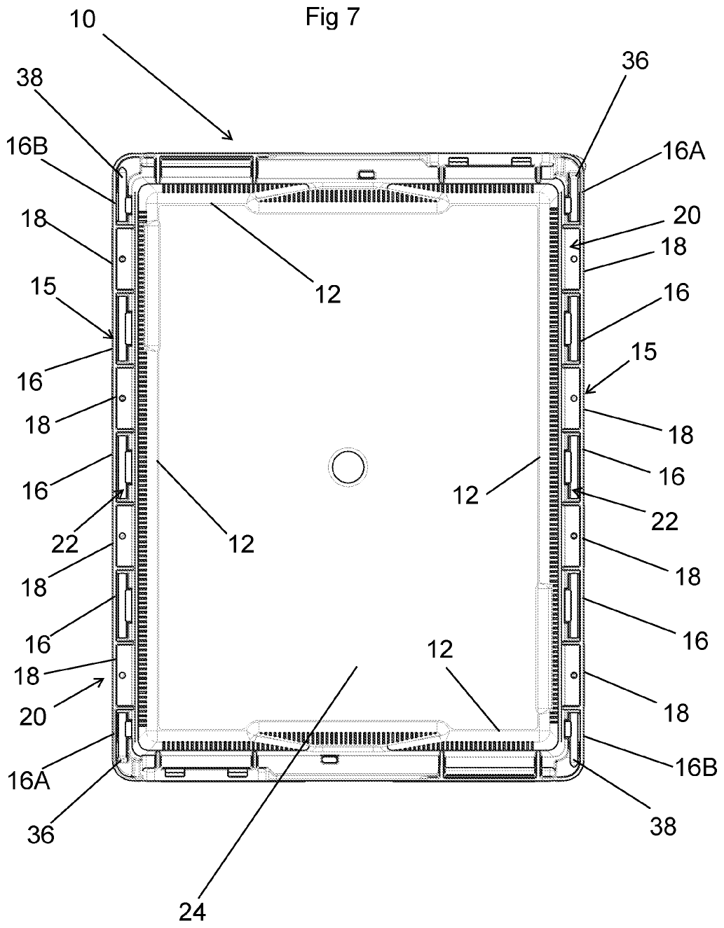

FIG. 7 is a view from below of the container.

The drawings show a container 10 comprising a first part in the form of a wall 12, and a second part in the form of a lid 14. The lid 14 is pivotally attached to the wall 12 by a hinge assembly 15.

The wall 12 has a plurality of spaced first hinge members 16 forming part of the hinge assembly 15. The lid 14 has a plurality of spaced second hinge members 18 also forming part of the hinge assembly 15.

The first and second hinge members 16, 18 form a pivot arrangement 20. A hinge pin 22 extends through the pivot arrangement 20, thereby forming the hinge assembly 15. The hinge pin 22 and the pivot arrangement 20 includes a securing arrangement in the form of interacting securing formations 26 (see FIGS. 4 and 5) to inhibit extraction of the hinge pin 22 from the pivot arrangement 20. The interacting securing formations 26 are described below.

In more detail, the container 10 includes a base 24, a plurality of the walls 12 extending upwardly from the base 24. The walls 12 define an open top of the container 10. Two lids 14 extend across the open top.

The lids 14 are pivotally attached to respective opposite walls 12. The lids 14 extend across the open top and meet at a central region of the open top.

Each lid 14 is pivotally attached to the wall 12 by a respective one of the hinge assemblies 15. The first and second hinge members 16, 18 are arranged to form the pivot arrangement 20. Each of the first hinge members 16 and each of the second hinge members 18 comprises a main portion 28 across which the hinge pin 22 extends.

The main portion 28 of each of the first and second hinge members 16, 18 defines a respective receiving formation 30 for receiving the hinge pin 22 therethrough to hold the hinge pin 22 in the pivot arrangement 20. Each receiving formation 30 is a bore defined through the respective first and second hinge member 16, 18. In the pivot arrangement 20, the aligned receiving formations 30 of the first and second hinge members 16, 18 form a channel 29 through which the hinge pin 22 extends.

As shown in FIG. 3, in the pivot arrangement 20, the first hinge members 16 are received in the spaces between the second hinge members 18. The second hinge members 18 are received in the spaces between the first hinge members 16. Thus, the first and second hinge members 16, 18 alternate relative to one another. When so arranged, the first and second hinge members 16, 18 are disposed in alignment. The hinge pin 22 is received through the pivot arrangement 20 to form the hinge assembly 15.

The pivot arrangement 20 has opposite ends at which one of the first hinge members 16 constitutes a proximal first hinge member 16A at one end of the pivot arrangement 20. In addition, one of the first hinge members 16 constitutes a distal first hinge member 16B at the opposite end of the pivot arrangement 20.

The proximal first hinge member 16A defines an end opening 32 to provide communication with the receiving formation 30 defined by the aligned first and second hinge members 18.

The hinge pin 22 is shown in FIG. 6 and comprises an elongate member 34 having a proximal end 36 at a proximal end region 36A. The elongate member 34 further includes a distal end 38 at a distal end region 38A.

The hinge pin 22 is installed into the pivot arrangement 20 by being inserted through the first and second hinge members 16, 18 via the end opening 32, with the distal end 38 leading the proximal end 36.

The hinge pin 22 and the pivot arrangement 20 include interacting securing formations 26 to inhibit extraction of the hinge pin 22 from the pivot arrangement 20. The interacting securing formations 26 of the hinge pin 22 comprise two detent formations in the form of first and second barbs 40, 42.

The first barb 40 is provided at the proximal end region 36A of the elongate member 34. The second barb 42 is provided at the distal end region 38A. Both of the first and second barbs 40, 42 extend from the elongate member 34 away from the distal end 38. Thus, the first and second barbs 40, 42 extend from the elongate member 34 in the opposite direction to the direction of insertion of the hinge pin 22 into the pivot arrangement 20.

The interacting securing formations 26 of the pivot arrangement 20 comprise a first shoulder 44 at the proximal first hinge member 16A (see FIG. 4), and a second shoulder 46 at the distal first hinge member 16B (see FIG. 5). The first and second shoulders 44, 46 extend from the main portion 28 of the respective proximal and distal first hinge members 16A, 16B.

When the hinge pin 22 is fully received in the channel 29, the first and second barbs 40, 42 interact with the first and second shoulders 44, 46 by engaging therewith. Thus, the first barb 40 engages the first shoulder 44 and the second barb 42 engages the second shoulder 46. As a result, the hinge pin 22 cannot be removed from the channel 29 without first disengaging the first and second barbs 40, 42 from the first and second shoulders 44, 46.

A stop formation 48 is provided at the proximal end 36 of the elongate member 34. The stop formation 48 is received in the end opening 32 and engages the proximal first hinge member 16A at the end opening 32 when the hinge pin 22 is fully received in the channel 29.

The end opening 32 and the stop formation 48 are correspondingly shaped so that the stop formation 48 can be received in the end opening 32 in only one orientation of the hinge pin 22. In this orientation, the first and second barbs 40, 42 are arranged to interact with the first and second shoulders 44, 46, as described above.

The correspondingly shaped end opening 32 and stop formation 48 prevent rotation of the hinge pin 22 about its longitudinal axis, thereby preventing the first and second barbs 40, 42 being rotated away from their position in engagement with the first and second shoulders 44, 46. Thus, accidental or opportunistic unauthorised removal of the hinge pin 22 from the pivot arrangement 20 is prevented.

In use, the first and second shoulders 44, 46 and the first and second barbs 40, 42 are arranged between the elongate member 34 of the hinge pin 22 and the main portion 28 of the respective first hinge member 16. As shown in FIG. 7, the first and second shoulders 44, 46 and the first and second barbs 40, 42 cannot be seen, thereby preventing access thereto by an opportunistic thief.

There is thus described an embodiment of a pivot arrangement and a container 10 in which the hinge pin 22 is provided with first and second barbs 40, 42, and the hinge members are provided with the first and second shoulders 44, 46. The first and second barbs 40, 42 and the first and second shoulders 44, 46 interact with one another, thereby preventing an opportunistic thief from removing the hinge pin 22 to open the container 10 lid 14.

Thus, the embodiment shown in the drawings provides the advantage of overcoming a problem associated with removable hinge pins. The ability to remove a hinge pin from a container makes it possible for a thief to access the contents of the container, then re-assemble the hinge so that no one will notice that the container has been accessed. With the above described embodiment, the hinge pin 22 has to be destroyed to remove it, thereby making it obvious that the container 10 has been tampered with.

Various modifications can be made without departing from the scope of the invention.

1. A hinge assembly comprising: a first part having a first hinge member; a second part having a second hinge member, the first and second hinge members forming a pivot arrangement to allow the first part to pivot relative to the second part; and a hinge pin extending across the pivot arrangement, thereby pivotally attaching the first part to the second part; wherein the hinge pin and the pivot arrangement include interacting securing formations to inhibit extraction of the hinge pin from the pivot arrangement.

2. (canceled)

3. A hinge assembly according to claim 1, wherein the hinge pin comprises an elongate member having a proximal end region and a distal end region, one of the hinge members including an end opening, the proximal end region being disposed at said end opening, and the interacting securing formation of the hinge pin being provided at one of the proximal and distal end regions of the elongate member.

4. (canceled)

5. A hinge assembly according to claim 1, wherein the interacting securing formations comprise a detent formation and a shoulder to engage the detent formation.

6. A hinge arrangement according to claim 5, wherein the interacting securing formation of the hinge pin comprises the projecting member, and the interacting securing formation of the pivot arrangement comprises the shoulder.

7. A hinge assembly according to claim 6, wherein the hinge pin comprises an elongate member having a proximal end region and a distal end region, and the projecting member is provided either at the proximal end region of the elongate member, or at the distal end region of the elongate member.

8. A hinge assembly according to claim 6, wherein the hinge pin comprises two of the projecting members, each projecting member being provided at a respective one of the proximal and distal end regions of the hinge pin.

9. A hinge assembly according to claim 6, wherein the, or each, projecting member projects from the elongate member towards the proximal end.

10. (canceled)

11. A hinge assembly according to claim 3, wherein the hinge pin comprises two of the interacting securing formations, each interacting securing formation being provided at a respective one of the proximal and distal end regions of the elongate member.

12. (canceled)

13. A hinge assembly according to claim 3, wherein the hinge pin includes a stop formation to engage the pivot arrangement at said end opening, the stop formation being provided at the proximal end region of the hinge pin elongate member.

14. A hinge arrangement according to claim 3, wherein the pivot arrangement has a proximal hinge member at which the proximal end region of the elongate member is disposed when the hinge pin is received by the pivot arrangement, and the pivot arrangement has a distal hinge member at which the distal end region of the elongate member is disposed when the hinge pin is received by the pivot arrangement, and the pivot arrangement has opposite ends, the end opening being defined in the proximal hinge member.

15. A hinge assembly according to claim 14, wherein each of the proximal and distal hinge members is a respective one of the first hinge members.

16. A hinge arrangement according to claim 15, wherein the interacting securing formation of the pivot arrangement is provided on the, or one of the, first hinge members, at one endo f the pivot arrangement.

17. A hinge assembly according to claim 1, comprising a plurality of the interacting securing formations of the pivot arrangement, each being provided on a respective one of the first hinge members.

18. (canceled)

19. A hinge assembly according to claim 17, wherein the pivot arrangement has two interacting securing formations, a respective interacting securing formation being provided at each of the opposite ends of the pivot arrangement, and both interacting securing formations of the pivot arrangement are provided on respective first hinge members.

20. A hinge assembly according to claim 19, wherein each of the interacting securing formations of the pivot arrangement comprises a respective shoulder, a first of the shoulders being provided at one end of the pivot arrangement, and a second of the shoulders being provided at the opposite end of the pivot arrangement.

21. A hinge arrangement according to claim 1, wherein the first and second hinge members are aligned to receive the hinge pin, each of the first hinge members and each of the second hinge members defines a respective receiving formation for receiving the hinge pin, the receiving formations forming a channel through which the hinge pin extends.

22. A hinge arrangement according to claim 1, wherein the first part comprises a plurality of the first hinge members, and the second part comprises a plurality of the second hinge members, the first and second hinge members alternating with respect to one another to form the pivot arrangement.

23. A container comprising: a wall having a first hinge member; a lid having a second hinge member; the first and second hinge members forming a pivot arrangement; and a hinge pin extending across the pivot arrangement, thereby pivotally attaching the lid to the wall; wherein the hinge pin and the pivot arrangement include interacting securing formations to inhibit extraction of the hinge pin from the pivot arrangement.

24. (canceled)

25. A hinge pin for use with a pivot arrangement, the hinge pin comprising an elongate member having a proximal end region and an opposite distal end region, and an interacting securing formation on the elongate member, the interacting securing formation being configured to interact with a further interacting securing formation of the pivot arrangement.

26. A hinge assembly according to claim 3, wherein the projecting member comprises a barb.
